(19) United States
(12) Patent Application Publication
(10) Pub. No.: US 2026/0364959 A1
(43) Pub. Date: Nov. 19, 2026

(54) PRINTER

(71) Applicant: SATO CORPORATION, Tokyo (JP)

(72) Inventors: Nuttawuth BUTHRATH, Tokyo (JP); Takayoshi JINNOUCHI, Tokyo (JP)

(73) Assignee: SATO CORPORATION, Tokyo (JP)

(21) Appl. No.: 19/155,123

(22) PCT Filed: Mar. 27, 2024
(86) PCT No.: PCT/JP2024/012255

§ 371 Date: Aug. 8, 2025

(30) Foreign Application Priority Data
Mar. 30, 2023 (JP) 2023-054575
Mar. 22, 2024 (JP) 2024-046060

(51) Int. Cl. B41J 11/00; B41J 2/325; B41J 2/375; B41J 3/407; B41J 11/46; B41J 15/04; B41J 29/377

(52) U.S. Cl. CPC B41J 11/0095; B41J 2/325; B41J 2/375; B41J 3/4075; B41J 11/46; B41J 15/046; B41J 15/048; B41J 29/377; B41J 2203/01

(57) ABSTRACT

One aspect of the present invention is a printer including: a feed roller that feeds a continuous body and an ink ribbon; a print head that prints information on each of the print media of the continuous body, the print head and the feed roller pinching the ink ribbon and the continuous body at a print position; and a first detection unit that is provided upstream of the print position in a feed direction of the continuous body, the first detection unit detecting an end of each of the print media in the feed direction of the continuous body. The first detection unit has a light-emitting element and a light-receiving element receiving, via the ink ribbon and the continuous body, light emitted from the light-emitting element.

### FIELD

The present invention relates to a printer.

### BACKGROUND

Conventionally, there are known printers feeding a continuous paper that includes a band-shaped liner and print media such as labels peelably attached at intervals to the liner. Some of these printers include a sensor for detecting the print medium at the time of printing on the print medium the information such as letters, symbols, a figure, or a bar code.

For example, Japanese Patent Application Publication No. 2019-73025 describes a printer including a sensor. The sensor detects a position of a continuous paper that has been fed to an upper surface of a sheet guide. The printer is configured to determine timing for printing, based on the information detected by the sensor, and thereby print desired information on a label of the continuous paper.

### BRIEF SUMMARY

### Technical Problem

Incidentally, in the conventional printers, the sensor for detecting a print medium is mounted at a position upstream of and relatively distant from a thermal head that performs printing on a feed path for a print medium. For example, in the printer described in Japanese Patent Application Publication No. 2019-73025 (refer to FIG. 10) mentioned above, a sensor unit including the sensor is arranged at a position upstream of and relatively distant from a platen roller that pinches a label with the thermal head at the time of printing. Thus, there may be a case where accuracy of a print start position on the print medium based on a detection result of the sensor is not sufficient. The possible causes for the above may be as follows.

A diameter of the platen roller in the printer expands or contracts, accompanying a temperature change, and also contracts due to wear of the roller. Further, in a case of a large paper roll, a large feeding load acts on the sheet at the time of feeding the print medium, and thus, the sheet easily slips. Particularly, at the time of the start of the feeding, the print medium easily slips at a location where the print medium is held between the thermal head and the platen roller. For this reason, even when a rotational amount of the platen roller for feeding the continuous paper from a sensor detection position to the print start position is preset based on the physical distance, there is a possibility of occurrence of the slight displacement from the print start position. When a distance along the feed path between the sensor detection position and the print start position is long, the set rotational amount of the platen roller is large, and thus, effects of a diameter change and slippage of the platen roller accumulate. As a result, the displacement of the print start position may become non-negligible. Particularly, when a length of the single label (print medium) in a feed direction is short and a plurality of labels are included between the sensor detection position and the thermal head, the platen roller repeatedly rotates forward and backward in some cases, and thus, the substantial feeding amount is increased. As a result, the displacement of the print start position tends to become noticeable.

In view of the above, an object of the present invention is to improve accuracy of a print start position for each print medium at the time of printing information on each print medium of a continuous body that includes a band-shaped liner and a plurality of print media peelably attached at intervals on the liner.

### Solution to Problem

An aspect of the present invention provides a printer including:
a feed roller that feeds a continuous body and an ink ribbon, the continuous body including a band-shaped liner and a plurality of print media peelably attached at intervals on the liner;
a print head that prints information on each of the print media of the continuous body, the print head and the feed roller pinching the ink ribbon and the continuous body at a print position; and
a first detection unit that is provided upstream of the print position in a feed direction of the continuous body, the first detection unit comprising a light-emitting element and a light-receiving element receiving, via the ink ribbon and the continuous body, light emitted from the light-emitting element, to detect an end of each of the print media in the feed direction of the continuous body.

### Advantageous Effects

An aspect of the present invention can improve accuracy of a print start position for each print medium at the time of printing information on each print medium of a continuous body that includes a band-shaped liner and a plurality of print media peelably attached at intervals on the liner.

### BRIEF DESCRIPTION OF DRAWINGS

FIG. 1 is a perspective view of a printer according to one embodiment.

FIG. 2 illustrates a perspective view of the printer according to one embodiment, with the interior visible, and also illustrates a configuration of a continuous paper.

FIG. 3 is a side view of the printer according to one embodiment, with the interior visible,

FIG. 4 is a perspective view of a printing unit of the printer according to one embodiment while a print head unit is in an opened state.

FIG. 5 illustrates perspective views of a label support mechanism unit of the printer according to one embodiment.

FIG. 6 is a partial sectional view of a label support mechanism unit of the printer according to one embodiment.

FIG. 7 is a perspective view of a part of a head mechanism unit of the printer according to one embodiment, viewed from above.

FIG. 8 is a perspective view of a part of the head mechanism unit of the printer according to one embodiment, viewed from below.

FIG. 9 includes an exploded perspective view of a head assembly incorporated in the head mechanism unit, and a sectional view of a thermal head.

FIG. 10 is an exploded perspective view of a part of the head mechanism unit in FIG. 7.

FIG. 11 is an illustration for a method of assembling a sensor assembly to a head cover in the printer according to one embodiment.

FIG. 12 is an illustration for a method of assembling the sensor assembly to the head cover in the printer according to one embodiment.

FIG. 13 includes a partial plan view of the head cover in the printer according to one embodiment, and an enlarged partial sectional view of the head cover to which the sensor assembly has been assembled.

FIG. 14 illustrates the head mechanism unit in FIG. 8 from which the head cover has been detached.

FIG. 15 is a partial sectional view of the printer according to one embodiment.

FIG. 16 is an enlarged view of a part in FIG. 15, which is related to a light transmission type sensor.

FIG. 17 illustrates a head position adjustment mechanism in the printer according to one embodiment.

FIG. 18 is a partial sectional view illustrating a positional relation in the vicinity of the light transmission type sensor before and after the head position adjustment in the printer according to one embodiment.

### DETAILED DESCRIPTION

The below-described configurations are not limited to those in the drawings described in “Brief Description of Drawings”.

In the following description, “feed path” does not refer to a specific member in the printer, but refers to a path that a continuous paper or an ink ribbon follows at the time of being fed in the printer (in other words, refers to a space through which the continuous paper or the ink ribbon can pass in the printer).

A first aspect of the present invention provides a printer including:
a feed roller that feeds a continuous body and an ink ribbon, the continuous body including a band-shaped liner and a plurality of print media peelably attached at intervals on the liner;
a print head that prints information on each of the print media of the continuous body, the print head and the feed roller pinching the ink ribbon and the continuous body at a print position; and
a first detection unit that is provided upstream of the print position in a feed direction of the continuous body, the first detection unit comprising a light-emitting element and a light-receiving element receiving, via the ink ribbon and the continuous body, light emitted from the light-emitting element, to detect an end of each of the print media in the feed direction of the continuous body.

According to the first aspect of the present invention, the light-emitting element and the light-receiving element of the first detection unit can be arranged close to the print position. Thus, accuracy of the print start position for each print medium can be improved.

A second aspect of the present invention provides the printer according to the first aspect, including a medium support part that includes a support surface, wherein the support surface supports, from a side of the liner, the continuous body fed toward the feed roller, and

the light-emitting element is arranged on a side on which the print head is provided, relative to a feed path along which the ink ribbon is fed toward the feed roller, and the light-receiving element receives the light at the support surface.

According to the second aspect of the present invention, the light-emitting element and the light-receiving element of the first detection unit can be arranged at a position close to the print position.

A third aspect of the present invention provides the printer according to the first or second aspect, wherein the print head includes a substrate on which a heat-generating part is provided, and

the light-emitting element is arranged directly below the substrate.

According to the third aspect of the present invention, the light-emitting element can be arranged close to the print position.

A fourth aspect of the present invention provides the printer according to any one of the first to third aspects, wherein the print head includes a heat-dissipating part, and

the light-emitting element is arranged between the heat-dissipating part and the ink ribbon.

According to the fourth aspect of the present invention, the light-emitting element of the first detection unit can be arranged at a position close to the print position.

A fifth aspect of the present invention provides the printer according to any one of the first to fourth aspects, wherein when the printer is viewed from a side of the printer, a direction from a position of the light-emitting element toward a position of the light-receiving element is inclined from an imaginary vertical line to a side on which the print position is set, the imaginary vertical line extending from the position of the light-emitting element, vertical to a mounting surface on which the printer is mounted.

According to the fifth aspect of the present invention, the light-emitting element of the first detection unit can be arranged at a position close to the print position.

A sixth aspect of the present invention provides the printer according to any one of the first to fifth aspects, wherein when the printer is viewed from a side of the printer, the print head has a thickness that decreases along a direction opposite to a feed direction of the ink ribbon, and thereby, a space is formed between the print head and the ink ribbon, and
the light-emitting element is arranged in the space.

According to the sixth aspect of the present invention, the light-emitting element of the first detection unit can be arranged at a position close to the print position.

A seventh aspect of the present invention provides the printer according to any one of the first to sixth aspects, wherein a feed path for the ink ribbon and a feed path for the continuous body are set so as to approach a mounting surface for the printer along an upstream direction from the print position, the mounting surface being a surface on which the printer is mounted.

According to the seventh aspect of the present invention, the light-emitting element can be provided in a space directly below a substrate of the print head so as to be in close proximity to a heat-generating part of the print head.

An eighth aspect of the present invention provides the printer according to the third aspect, including a head cover arranged between the substrate and a feed path for the ink ribbon, wherein

the light-emitting element is accommodated in the head cover.

According to the eighth aspect of the present invention, superior space efficiency is achieved for arrangement of the light-emitting element near the print head.

A ninth aspect of the present invention provides the printer according to the eighth aspect, wherein a through-hole is formed in the head cover to allow light emitted by the light-emitting element to pass through the through-hole.

According to the ninth aspect of the present invention, the light-emitting element can emit light toward the light-receiving element while being accommodated in the head cover.

A tenth aspect of the present invention provides the printer according to any one of the first to ninth aspects, including a guide that is provided upstream of the light-receiving element in the feed direction, and guides, from above, the continuous body fed toward the feed roller.

According to the tenth aspect of the present invention, the guide supports the continuous body. Thus, a movement amount of the continuous body in a direction perpendicular to the liner is restricted, and thus, detection accuracy of the first detection unit is further improved.

An eleventh aspect of the present invention provides the printer according to any one of the first to tenth aspects, including a second detection unit that is provided upstream of the first detection unit in the feed direction of the continuous body and detects an end of each of the print media in the feed direction of the continuous body, wherein the second detection unit includes a light-emitting element and a light-receiving element arranged such that one of the light-emitting and light-receiving elements in the second detection unit is more distanced from a mounting surface for the printer than the other of the light-emitting and light-receiving elements in the second detection unit and is arranged between a feed path for the ink ribbon and a feed path for the continuous body, the mounting surface being a surface on which the printer is mounted.

According to the eleventh aspect of the present invention, the two detection units are provided at different positions in the feed direction. Thus, either detection unit can be flexibly used depending on an accuracy requirement for the print start position for each of the print media.

The following describes an embodiment in detail with reference to the drawings.

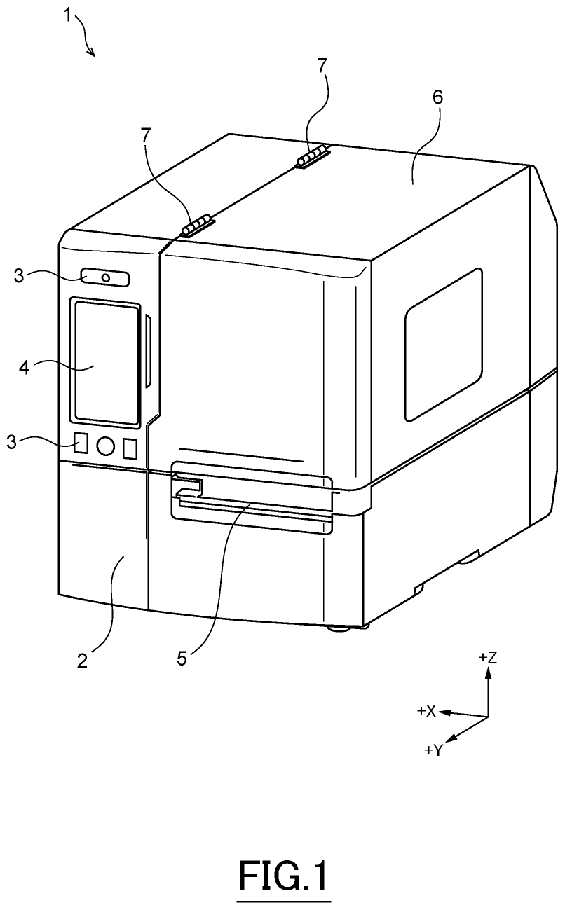

FIG. 1 illustrates an appearance of a printer 1 according to one embodiment. For convenience of the following description, XYZ coordinates are defined as illustrated in FIG. 1. In other words, +X and −X indicate the left and right directions of the printer 1 respectively, +Y and −Y indicate the front and rear directions of the printer 1 respectively, and +Z and −Z indicate the up and down directions of the printer 1 respectively.

The printer 1 includes an output opening 5 on a front surface of the printer 1. The output opening 5 is provided for outputting (discharging) printed labels. An openable cover 6 is attached to a side surface on one lateral side in the printer 1 by hinges 7 at two positions such that the openable cover 6 can be opened and closed in the up and down directions.

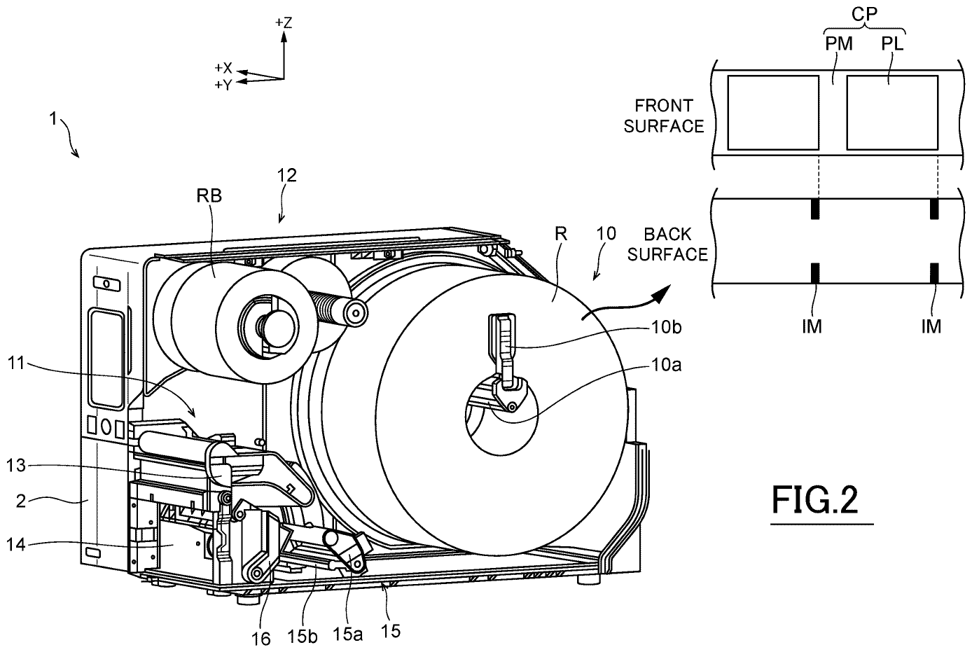

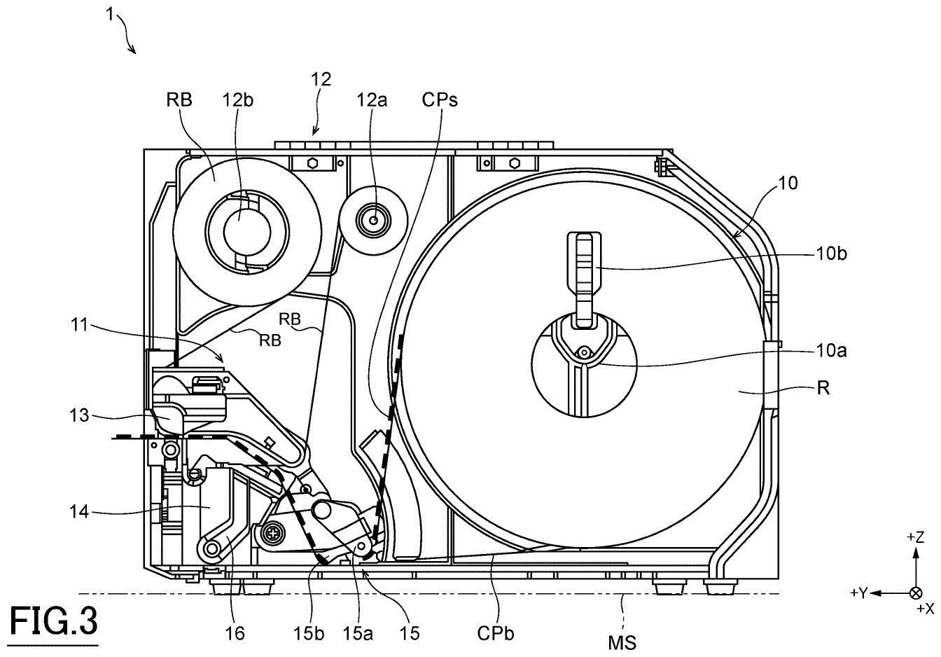

FIG. 2 and FIG. 3 are a perspective view and a side view, respectively, illustrating a main part of the printer 1 in a state where the interior is visible.

The printer 1 includes a sheet supply unit 10, a printing unit 11, and an ink ribbon unit 12 that are mounted inside the printer 1. The sheet supply unit 10 is arranged on a rear side. The printing unit 11 is arranged on a front side. The ink ribbon unit 12 is arranged on an upper side.

The sheet supply unit 10 is loaded with a paper roll R. As illustrated in FIG. 2, the paper roll R is a continuous paper CP wound into a roll shape. The continuous paper CP includes a band-shaped liner PM and a plurality of labels PL peelably attached at intervals on the liner PM. The liner PM includes a surface (front surface) with which adhesive surfaces of the labels PL contact and that is formed by a coat of a peeling agent such as silicone to enable the labels PL to be easily peeled. The liner PM includes a surface (back surface) on which the labels PL are not affixed. Position detection marks IM may be formed at a predetermined interval along the longitudinal direction on the back surface of the liner PM. The position detection marks IM indicate positions of the labels. Examples used as the label PL include thermal paper and plain paper. In the case of the thermal paper, a thermal coloring layer is formed on a front surface of the thermal paper. The thermal coloring layer develops a specific color (such as black or red) when a temperature of the layer reaches a predetermined range. Alternatively, the sheet supply unit 10 can be loaded with a paper roll that is a linerless label wound in a roll shape, which is not illustrated. The linerless label includes a print surface and an adhesive surface that is formed by applying an adhesive to a side opposite to the print surface.

The sheet supply unit 10 includes a support shaft 10a and a roll guide 10b, and holds the paper roll R and supplies, to the printing unit 11, the continuous paper CP pulled out from the paper roll R. The support shaft 10a supports the paper roll R such that the paper roll R is freely rotatable. The roll guide 10b holds the paper roll R. The roll guide 10b is mounted such that the roll guide 10b is freely movable along an axial direction of the support shaft 10a such that a position of the roll guide 10b can be changed depending on a width of the paper roll R.

There are two types of the continuous paper CP: a face-out wound label and a face-in wound label. The face-out wound label is wound such that the labels PL of the continuous paper CP are positioned on an outer peripheral surface of the paper roll R, and the continuous paper CPs (dashed line) is pulled out from the vicinity of a height-direction center of the sheet supply unit 10 toward a bottom portion of the printing unit 11, as illustrated in FIG. 3. Meanwhile, the face-in wound label is wound such that the labels PL of the continuous paper CP are positioned on an inner peripheral surface of the paper roll R, and the continuous paper CPb (solid line) is pulled out from the vicinity of an internal bottom surface of the printer 1 toward the bottom portion of the printing unit 11, as illustrated in FIG. 3. A sheet pass route of the continuous paper CP (CPs, CPb) in the printing unit 11 is the same whether the continuous paper CP is face-out wound or face-in wound. The continuous paper CP is fed while the labels PL face upward, whether the continuous paper CP is face-out wound or face-in wound.

The printing unit 11 includes a print head unit 13, a support base 14 arranged on a lower side of the print head unit 13, and a damper 15, and prints on the labels PL of the continuous paper CP.

The print head unit 13 is mounted inside the printer 1 to be freely openable and closable as described below. When the print head unit 13 is in a closed state, the sheet pass route is formed between the print head unit 13 and the support base 14. The sheet pass route is connected to the output opening 5 (refer to FIG. 1).

A head lock lever 16 is provided at the support base 14. The head lock lever 16 keeps the print head unit 13 in the closed state. Operating the head lock lever 16 causes the print head unit 13 to be released from the closed state, and causes a front portion of the print head unit 13 to be lifted so that the print head unit 13 is opened (separated from the platen roller 23).

The damper 15 applies tension to the continuous paper CP. In the present embodiment, the damper 15 includes an outer damper 15a and an inner damper 15b, and moves up and down (opens and closes) in conjunction with the opening and closing of the print head unit 13. The outer damper 15a and the inner damper 15b are each provided to be freely swingable so as to apply tension to the continuous paper CP when the print head unit 13 is in the closed state.

The ink ribbon unit 12 includes a ribbon supply unit 12a and a ribbon winding unit 12b, and supplies an ink ribbon RB coated with printing ink and winds the supplied ink ribbon RB. The ribbon supply unit 12a supports the ink ribbon RB wound in a roll shape such that the ink ribbon RB is freely rotatable. The ribbon winding unit 12b winds and recovers the ink ribbon RB that has been used in printing. When the ink ribbon RB is used, the ink ribbon RB pulled out from the ribbon supply unit 12a is passed under the print head unit 13 and then wound by the ribbon winding unit 12b.

In such a printer 1, the continuous paper CP (CPs, CPb) pulled out from the paper roll R at the sheet supply unit 10 is fed via the damper 15 to the sheet pass route between the print head unit 13 and the support base 14, and printing processing is performed on the labels PL of the continuous paper CP in the course of the feeding. After the printing processing, the continuous paper CP is discharged from the output opening 5 to an outside of the printer 1.

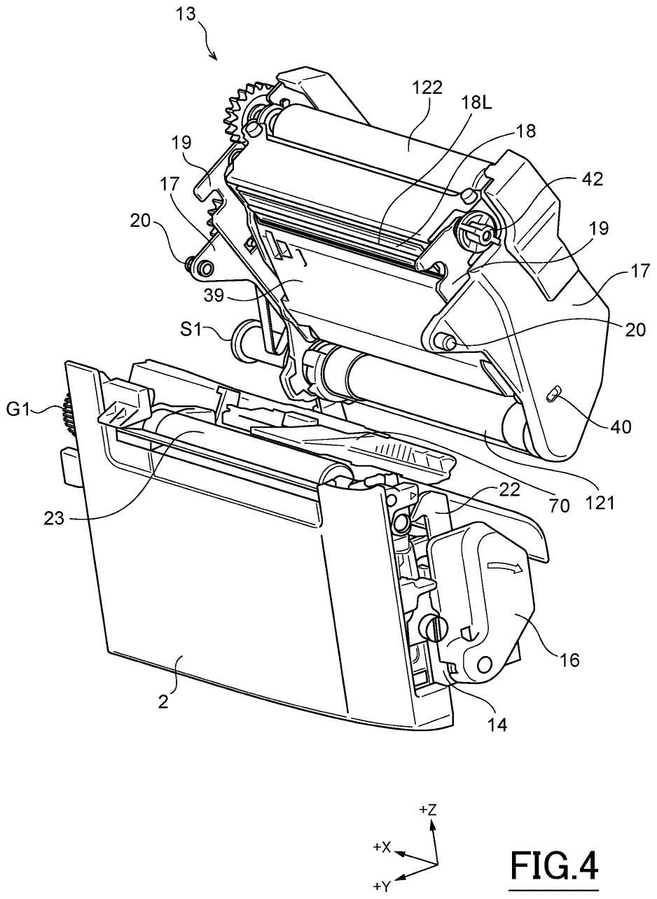

Next, a configuration of the printing unit 11 is described with reference to FIG. 4.

FIG. 4 is a perspective view of the printing unit 11 when the print head unit 13 is in an opened state.

As illustrated in FIG. 4, a swing shaft S1 is provided on a rear side in the print head unit 13. The swing shaft S1 is supported by a main frame (not illustrated) of the printer 1 so as to allow the print head unit 13 to freely swing (i.e., open and close) about the swing shaft S1 around the X axis.

The print head unit 13 includes a lower surface (the surface facing the sheet pass route) on which a thermal head 18 (one example of the print head) is arranged such that a heat-generating part 18L faces the sheet pass route. The heat-generating part 18L of the thermal head 18 includes a glaze layer that protrudes by a predetermined amount (e.g., 10 μm) from the substrate of the thermal head 18. The heat-generating part 18L includes a plurality of heat-generating resistors (heat-generating elements) that generate heat when electricity passes through the heat-generating resistors. Thus, the heat-generating part 18L prints on the label PL of the continuous paper CP. A plurality of heat-generating resistors are arranged in parallel in a width direction (the direction perpendicular to the feed direction of the continuous paper CP) of the continuous paper CP.

A pair of engagement claws 19 (refer to FIG. 4) are provided, on the lower surface of the print head unit 13, at a front-side position in the print head unit 13 so as to sandwich the axis of the thermal head 18 between the engagement claws 19. Pins 20 are provided, in the print head unit 13, on a rear side of the engagement claws 19. The pins 20 protrude outward from both side surfaces of the print head unit 13.

The print head unit 13 is biased in an opening direction by a torsion spring (not illustrated) attached to the swing shaft S1. However, the print head unit 13 is kept in the closed state by engagement between a pair of the pins 20 provided at a lower portion of the print head unit 13 and a pair of lock claws 22 provided at the support base 14. Operating the head lock lever 16 rearward causes the lock claws 22 to move rearward in conjunction with the operation and thereby disengage from the pins 20. Once the lock claws 22 disengage from the pins 20, the print head unit 13 automatically opens by the biasing force of the torsion spring.

When the print head unit 13 is in the closed state, a pair of the engagement claws 19 (refer to FIG. 4) of the print head unit 13 are fitted onto both ends of a rotational shaft of the platen roller 23 (one example of the feed roller).

The platen roller 23 feeds, to the output opening 5 along the sheet pass route (refer to FIG. 1), the continuous paper CP pulled out from the sheet supply unit 10. The platen roller 23 is arranged at an upper portion of the support base 14 so as to be rotatable in forward and reverse directions. The platen roller 23 rotates at the time of the printing, while the platen roller 23 and the thermal head 18 pinch the continuous paper CP. A gear G1 is coupled to one axial end of the rotational shaft of the platen roller 23. The gear G1 meshes with a rotational shaft of a stepping motor (not illustrated).

When the continuous paper CP is plain paper, the platen roller 23 rotates at the time of the printing while the platen roller 23 and the thermal head 18 pinch the continuous paper CP and the ink ribbon RB. In this case, the ink ribbon RB is fed from the ribbon supply unit 12a via ribbon rollers 121 and 122 (refer to FIG. 4) provided in the print head unit 13, and is then wound by the ribbon winding unit 12b.

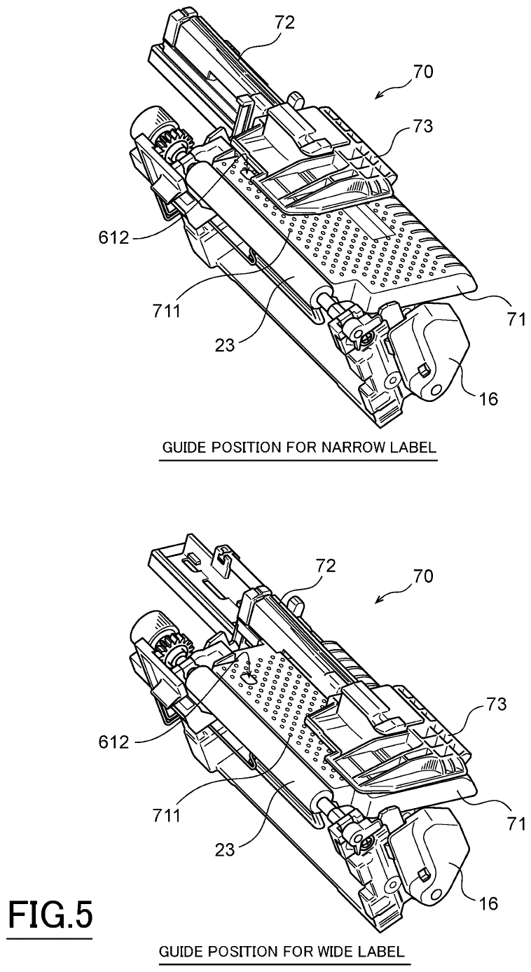

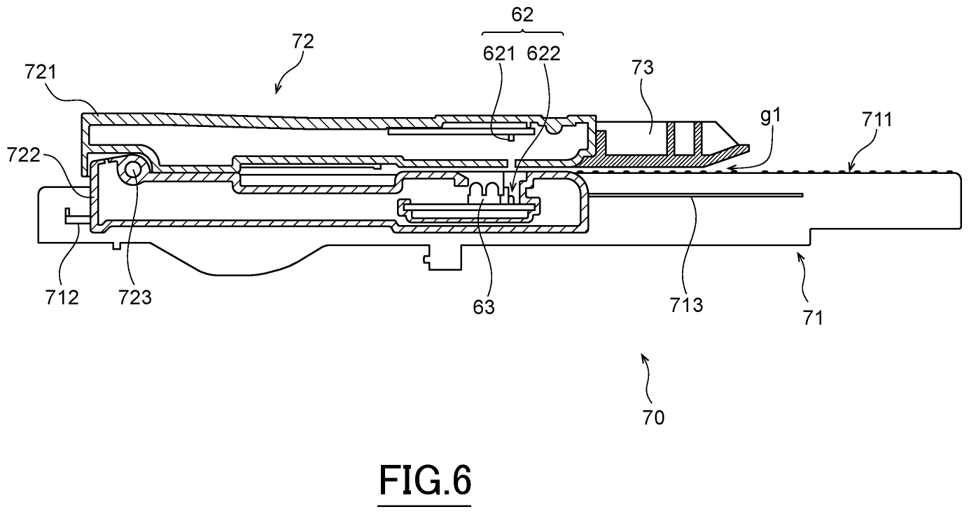

Next, a label support mechanism unit 70 is described with reference to FIG. 5 and FIG. 6.

As illustrated in FIG. 4, the label support mechanism unit 70 is arranged on the support base 14.

FIG. 5 illustrates perspective views of the label support mechanism unit 70 both in a case of a guide position for a narrow label and in a case of a guide position for a wide label.

As illustrated in FIG. 5, the label support mechanism unit 70 includes a label support part 71, a sensor assembly 72, and a label guide 73 (one example of the guide). The label support part 71 (one example of the medium support part) includes a support surface 711 that supports, from below, the continuous paper CP fed toward the platen roller 23. In one embodiment, a large number of projections are formed on the support surface 711 so as to enable the linerless label as the continuous paper to be smoothly fed. The linerless label is a label that includes an print surface and an adhesive surface formed by applying an adhesive to a side opposite to the print surface. A large number of the projections on the support surface 711 serve to reduce contact area between the support surface 711 and the adhesive surface of the linerless label, thereby aiding the feeding of the linerless label.

The sensor assembly 72 is attached to the label support part 71 such that the sensor assembly 72 can be operated to slide in a width direction of the continuous paper CP. A light transmission type sensor and a reflection type sensor are incorporated in the sensor assembly 72. The label guide 73 is attached to the sensor assembly 72. The label guide 73 catches, between the label guide 73 and the support surface 711 of the label support part 71, the continuous paper CP fed toward the platen roller 23, and thus serves to guide the continuous paper CP from above.

FIG. 6 schematically illustrates a section of the sensor assembly 72 and the label guide 73 when the label support mechanism portion 70 is cut by a plane perpendicular to a surface of the fed continuous paper CP and extending in a width direction (X direction) of the continuous paper CP.

As illustrated in FIG. 6, the label guide 73 is attached to the sensor assembly 72. A slight gap g1 is formed between a lower surface of the label guide 73 and the support surface 711 of the label support part 71. The gap g1 constitutes the feed path for the continuous paper CP.

The label support part 71 includes a guide projection 712 and a guide groove 713 each of which extends in a longitudinal direction of the label support part 71 and engages with the sensor assembly 72. The sensor assembly 72 can be slid in the longitudinal direction (i.e., the width direction of the continuous paper CP), depending on a width of the used label, while engaging with the guide projection 712 and the guide groove 713 of the label support part 71.

The sensor assembly 72 is structured to include a swing portion 721 on an upper side, a slide portion 722 on a lower side, and a swing shaft 723. The swing portion 721 and the slide portion 722 are swingably linked to each other by the swing shaft 723. The slide portion 722 can slide in the longitudinal direction while engaging with the guide projection 712 and the guide groove 713 of the label support part 71. The swing portion 721 can swing about the swing shaft 723 from a position (the position at the time of operation of the printer 1) illustrated in FIG. 6 where the swing portion 721 adjoins the slide portion 722, so as to move in a direction away from the slide portion 722 (i.e., counterclockwise in FIG. 6). Thereby, a new continuous paper CP is allowed to be set in the printer 1.

As illustrated in FIG. 6, in the sensor assembly 72, a light-emitting element 621 is arranged at the swing portion 721, and a light-receiving element 622 is arranged at the slide portion 722. The light-emitting element 621 and the light-receiving element 622 face each other and constitute the light transmission type sensor 62. Since a feed path for the ink ribbon RB is on an upper side of the label guide 73, the light-emitting element 621 on an upper side of the light-receiving element 622 is arranged between the feed path for the ink ribbon RB and the feed path for the continuous paper CP. When the light-receiving element 622 receives light emitted from the light-emitting element 621, the light transmission type sensor 62 detects an end of each label PL in the feed direction of the continuous paper CP, based on a difference in received light intensity between the light transmitted through the label PL and the liner PM and the light transmitted through only the liner PM.

In FIG. 6, the light-emitting element 621 is arranged on an upper side of the light-receiving element 622 (i.e., at a position farther away from the mounting surface MS (refer to FIG. 3) on which the printer 1 is mounted). However, there is no limitation to this. The positions of the light-emitting element 621 and the light-receiving element 622 may be replaced with each other such that the light-receiving element 622 is arranged on an upper side of the light-emitting element 621.

The reflection type sensor 63 is arranged at the slide portion 722. The reflection type sensor 63 includes a light-emitting element and a light-receiving element that are arranged in parallel. The reflection type sensor 63 detects the end of each label PL in the feed direction of the continuous paper CP, based on a difference in light intensity between an area where the position detection mark IM (refer to FIG. 2) is present and an area where the position detection mark IM is absent, concerning the light emitted from the light-emitting element and reflected by the back surface of the liner PM.

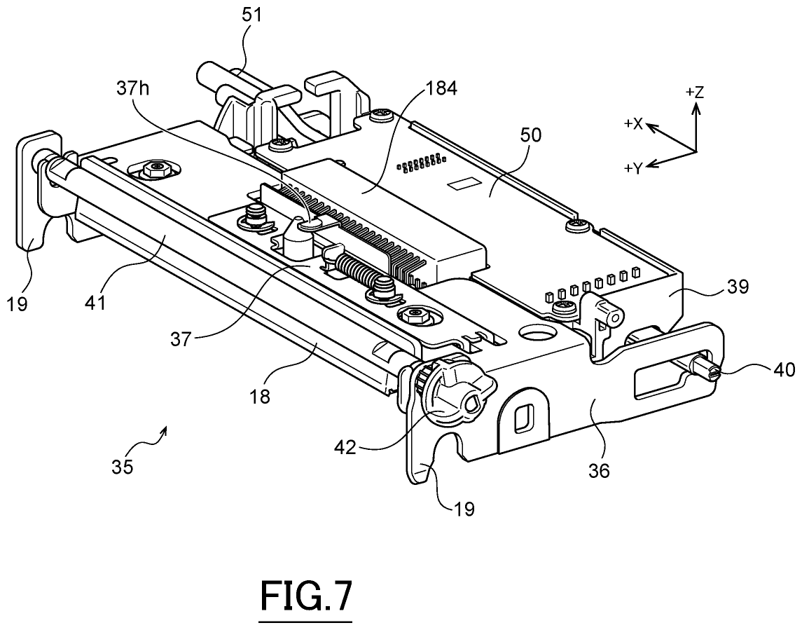

Next, a head mechanism unit 35 provided in the print head unit 13 is described with reference to FIG. 7 to FIG. 14. The head mechanism unit 35 is a mechanism related to the thermal head 18, in a state where support plates 17, the ribbon rollers 121 and 122, the swing shaft S1, and the like are detached from the print head unit 13.

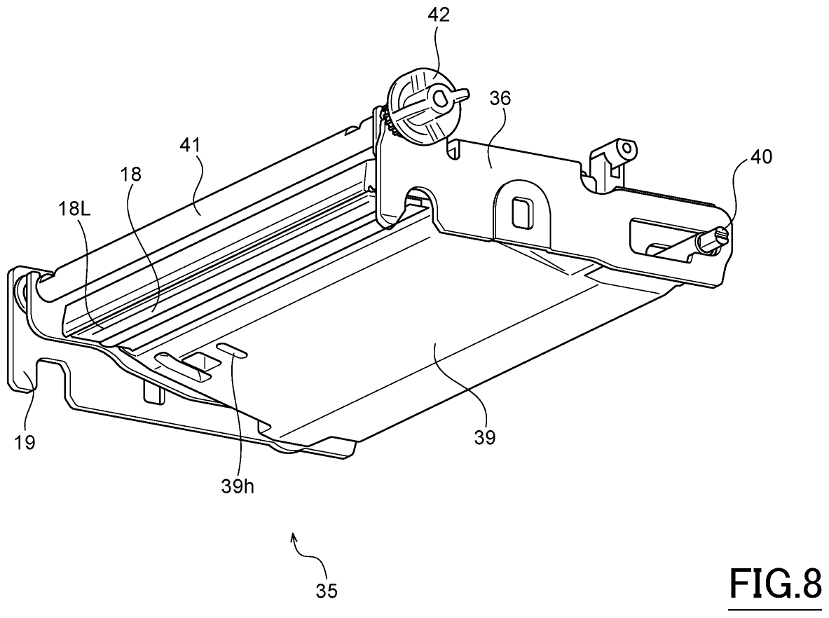

FIG. 7 is a perspective view of a main part of the head mechanism unit 35 viewed from above. FIG. 8 is a perspective view of the main part of the head mechanism unit 35 viewed from below.

As illustrated in FIG. 7 and FIG. 8, the head mechanism unit 35 includes the thermal head 18, a head holder 36, a pin pressing unit 37, a head cover 39, a swing shaft 40 (one example of the shaft portion), a rotational shaft 41, and the like.

Although invisible in FIG. 7 and FIG. 8, a head auxiliary member 38 is fixed to the thermal head 18.

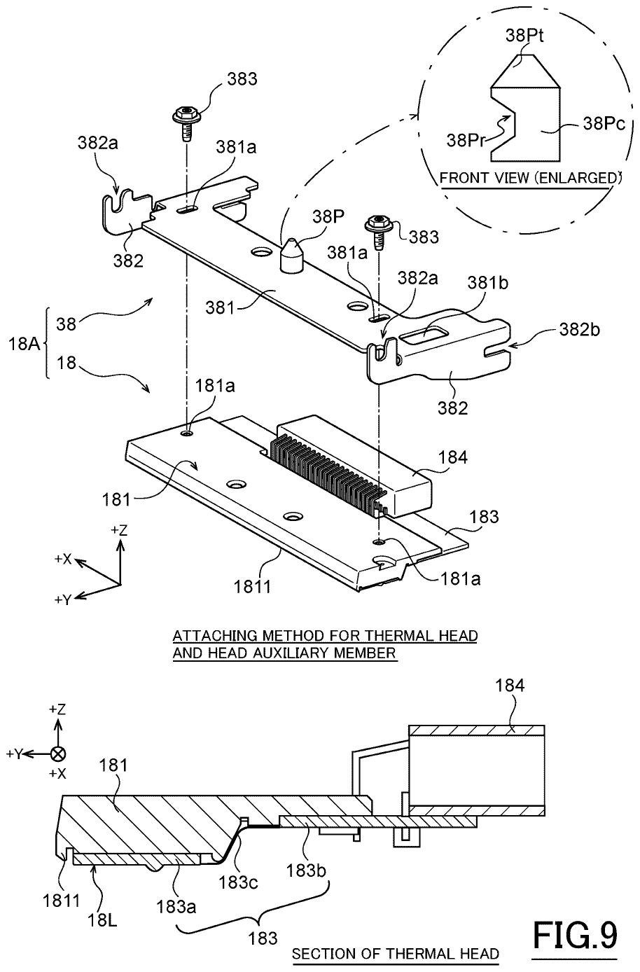

FIG. 9 includes an exploded perspective view illustrating a method for attaching the thermal head 18 and the head auxiliary member 38 to each other, and a sectional view of the thermal head 18 (a sectional view cut at a center in the longitudinal direction). As illustrated in FIG. 9, the head auxiliary member 38 is a plate-shaped member, and includes a central plate 381 and a pair of end plates 382 extending downward from both ends of the central plate 381. A pin 38P protruding upward is attached to an upper surface of the central plate 381. The pin 38P includes a columnar portion 38Pc extending upward from the surface of the central plate 381, and a tapered portion 38Pt tapering on an upper side of the columnar portion 38Pc. The columnar portion 38Pc includes a recess 38Pr formed to be recessed toward a +X side. As described below, the pin 38P is used for retaining the thermal head 18 by the head holder 36.

The thermal head 18 includes a heat sink 181 (one example of the heat-dissipating part), the substrate 183, and a connector 184. The substrate 183 may be constituted by two or more substrates connected to each other. The above-described heat-generating part 18L is formed on the substrate 183. The heat sink 181 is provided for efficiently dissipating heat generated in the substrate 183. The heat sink 181 includes screw holes 181a formed at two positions.

As illustrated in the sectional view of the thermal head 18, the substrate 183 includes a first substrate portion 183a on which the heat-generating part 18L is arranged, a second substrate portion 183b coupled to the connector 184, and a flexible substrate portion 183c connecting the first substrate portion 183a and the second substrate portion 183b to each other. The heat sink 181 is designed to be the thickest at the first substrate portion 183a in the substrate 183 so as to efficiently dissipate heat from the first substrate portion 183a generating the largest amount of heat.

A protrusion 1811 is formed at a distal end of the heat sink 181. The protrusion 1811 protrudes downward so as to cover a distal end of the first substrate portion 183a. Thereby, a jam can be prevented from occurring when the continuous paper CP (particularly, a thick paper) is back-fed (fed in the opposite direction).

As illustrated in FIG. 9, holes 381a are formed at two positions in the central plate 381 of the head auxiliary member 38. Fastening screws 383 via the holes 381a into the screw holes 181a of the thermal head 18 fixes the head auxiliary member 38 to the thermal head 18. In the following description, the integrated structure of the thermal head 18 and the head auxiliary member 38 is referred to as “head assembly 18A” as appropriate.

A pair of cutouts 382a are formed at front ends of the end plates 382 on both sides in the head auxiliary member 38. The cutouts 382a each have a U-shape that opens upward. Cutouts 382b are formed at rear ends of the end plates 382 on both sides in the head auxiliary member 38. As described below, the cutouts 382a are provided for adjusting a front-rear position of the thermal head 18.

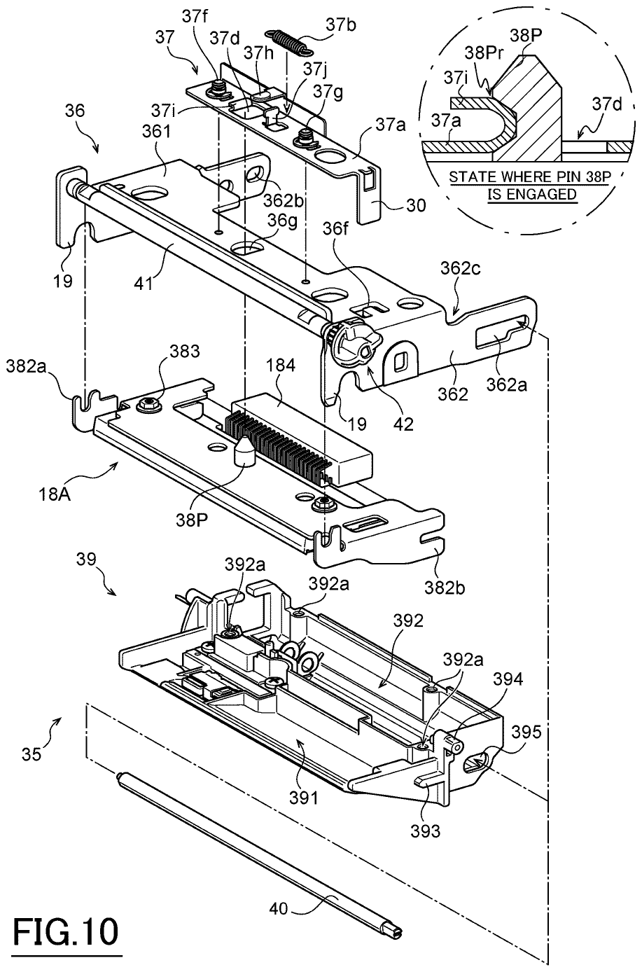

Next, a configuration of a main part of the head mechanism unit 35 is described with reference to FIG. 10. FIG. 10 is an exploded perspective view of the head mechanism unit 35 illustrated in FIG. 7. Although a circuit board 50 illustrated in FIG. 7 is fixed to the head cover 39, an illustration of the circuit board 50 is omitted in FIG. 10 for the sake of visibility of the head cover 39.

As illustrated in FIG. 10, the head mechanism unit 35 is configured to include the head holder 36, the head assembly 18A, and the head cover 39 that are assembled to each other in this order from above. The head holder 36 and the head cover 39 are supported by the swing shaft 40. The swing shaft 40 is arranged parallel to the axis of the platen roller 23. As illustrated in FIG. 4, the swing shaft 40 is supported by the support plates 17, and is fixed to an internal frame (not illustrated). The internal frame is located on an inner side of the support plates 17, and is configured integrally with the support plates 17.

The head holder 36 holds the head assembly 18A so as to be prevented from falling due to its own weight, and releases the holding of the head assembly 18A in response to predetermined operation on a head-holding release portion 30. Operating the head-holding release portion 30 allows the head assembly 18A to be easily detached from the head holder 36. Although not illustrated, the head-holding release portion 30 is exposed such that a user can operate the head-holding release portion when the print head unit 13 is at an opened position.

The head holder 36 includes a plate-shaped member including a support plate 361 and side walls 362 provided at both left and right ends of the support plate 361, and includes a pin pressing unit 37. The head holder 36 detachably holds the head assembly 18A. A pair of the engagement claws 19 that engage with both ends of the rotational shaft of the platen roller 23 are formed at front ends of the side walls 362 on both sides in the head holder 36. Insertion holes 362a and 362b through which the swing shaft 40 is inserted are formed at rear ends of the side walls 362 on both sides in the head holder 36.

An operational portion 42 is a rotational operation means for adjusting a position of the thermal head 18 in a front-rear direction by moving the head assembly 18A in the front-rear direction. Here, the front-rear direction refers to a front-rear direction in an assumed case where the front is defined as the direction in which the label PL already printed by the thermal head 18 advances. A position of the thermal head 18 is adjusted in the front-rear direction in order to achieve optimal print quality, depending on a type (a thickness, hardness, and the like) of the label.

The rotational shaft 41 is rotated in response to rotational operation on the operational portion 42. The rotational shaft 41 is rotatably supported by the side walls 362 on both sides of the support plate 361 in the head holder 36. The U-shaped cutouts 382a at both ends of the head assembly 18A are fitted onto both ends of the rotational shaft 41 from below. Thereby, the head assembly 18A is engaged with the rotational shaft 41. The rotational shaft 41 and the cutout portions 382a included in the head assembly 18A and engaging with the rotational shaft 41 constitute a position adjustment mechanism. The head position adjustment is described below in detail.

The printer 1 may include a mechanism for adjusting a pressing force of the thermal head 18 against the platen roller 23. With regard to an example including a pressing force adjustment mechanism, reference may be made to Japanese Patent Application Publication No. 2015-123628 filed by the applicant of the present application, entire content of which is incorporated by reference.

The pin pressing unit 37 includes a pressing plate 37a and a coil spring 37b. The pin pressing unit 37 presses the pin 38P of the head assembly 18A when the head assembly 18A is held by the head holder 36. The pressing plate 37a is provided on the support plate 361 by pins 37f and 37g such that the pressing plate 37a is slightly movable along a longitudinal direction (the width direction of the continuous paper CP) of the pressing plate 37a. The pins 37f and 37g are fixed by retaining rings or the like so as not to come out from the pressing plate 37a. The head-holding release portion 30 is formed as a portion bent downward from the pressing plate 37a. In other words, the pressing plate 37a and the head-holding release portion 30 are formed integrally with each other. The head-holding release portion 30 passes through a hole 36f formed in the support plate 361 and a hole 381b (refer to FIG. 9) formed in the head auxiliary member 38, and protrudes from the head mechanism unit 35 so as to be allowed to be operated.

The head-holding release portion 30 is exposed when the print head unit 13 is at the opened position (the position illustrated in FIG. 4). A user can remove the head assembly 18A from the head mechanism unit 35 by operating the head-holding release portion 30 in the +X direction.

A hole 36g is formed in the support plate 361 of the head holder 36. A hole 37d is formed in the pressing plate 37a of the pin pressing unit 37. The pin 38P of the head assembly 18A passes through the holes 36g and 37d, and protrudes upward from the hole 37d.

A projection 37j is formed between the hole 37d and the pin 37g in the pressing plate 37a so as to protrude upward. A protrusion 37i is formed at an edge portion of the hole 37d in the pressing plate 37a. The protrusion 37i has a shape protruding toward the projection 37j.

The coil spring 37b of the pin pressing unit 37 is attached between the pin 37g and the projection 37j. The pressing plate 37a is biased in the-X direction (the direction opposite to the direction D1 in FIG. 5) by the coil spring 37b. When the pressing plate 37a is biased by the coil spring 37b, the protrusion 37i engages with the recess 38Pr of the pin 38P protruding upward from the hole 37d, as illustrated by the enlarged sectional view of “a state where the pin 38P is engaged” in FIG. 10. Thereby, the pin 38P is locked by the pressing plate 37a, and the head assembly 18A is held by the head holder 36.

As illustrated in FIG. 7 and FIG. 10, the pin pressing unit 37 includes a pin contact piece 37h. The pin contact piece 37h is arranged slightly on the-X side from the tapered portion 38Pt of the pin 38P protruding upward from the hole 37d. In other words, the pin contact piece 37h is arranged at a position where the pin contact piece 37h contacts against the tapered portion 38Pt of the pin 38P when the head-holding release portion 30 is operated in the +X direction.

In order that the holding of the head assembly 18A by the head holder 36 is released, the head-holding release portion 30 may be operated in the +X direction as described above. In other words, the head-holding release portion 30 of the pressing plate 37a is moved in the opposite direction (+X direction) against the biasing force of the coil spring 37b. The movement of the pressing plate 37a in the +X direction causes the pin contact piece 37h to contact against the tapered portion 38Pt of the pin 38P and thus press down the pin 38P, and thereby causes the recess 38Pr of the pin 38P to disengage from the protrusion 37i of the pin pressing unit 37. As a result, the head assembly 18A falls due to its own weight.

The head cover 39 is configured so as to be swingable relative to the head holder 36 and cover at least a part of the thermal head 18 from below. An insertion hole 395 is formed in the head cover 39. The swing shaft 40 passes through the insertion hole 395. The head cover 39 can swing about the swing shaft 40.

A pair of guide projections 393 are formed on side portions on both sides in the head cover 39. A pair of the guide projections 393 engage with the cutouts 382b of the head assembly 18A. Thereby, the head assembly 18A and the head cover 39 are linked to each other. As described above, the head cover 39 is supported by the swing shaft 40, and the thermal head 18 and the head cover 39 are linked to each other. Thus, the thermal head 18 is supported by the swing shaft 40.

The head cover 39 includes a thermal head placement portion 391 on a front side and a circuit board fixing portion 392 on a rear side. The head assembly 18A is placed on the thermal head placement portion 391. Threaded portions 392a are formed in the circuit board fixing portion 392. The circuit board 50 is fixed by screwing screws into the threaded portions 392a via the circuit board 50 (refer to FIG. 7).

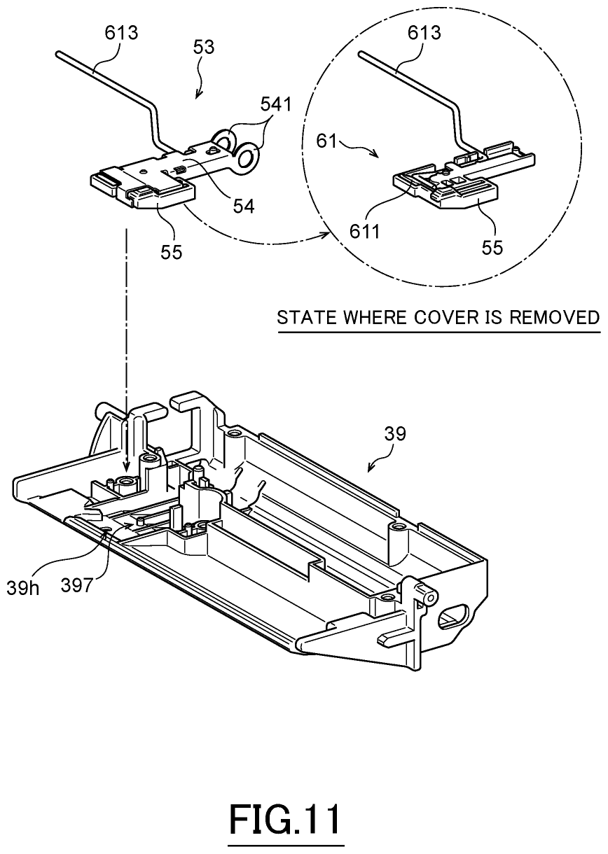

The head cover 39 accommodates a sensor assembly 53 including a light-emitting element 611 of the light transmission type sensor 61 (described below). As can be understood from FIG. 10 and FIG. 11, the sensor assembly 53 is accommodated in the head cover 39 so as to be arranged between the substrate 183 of the head assembly 18A and the head cover 39.

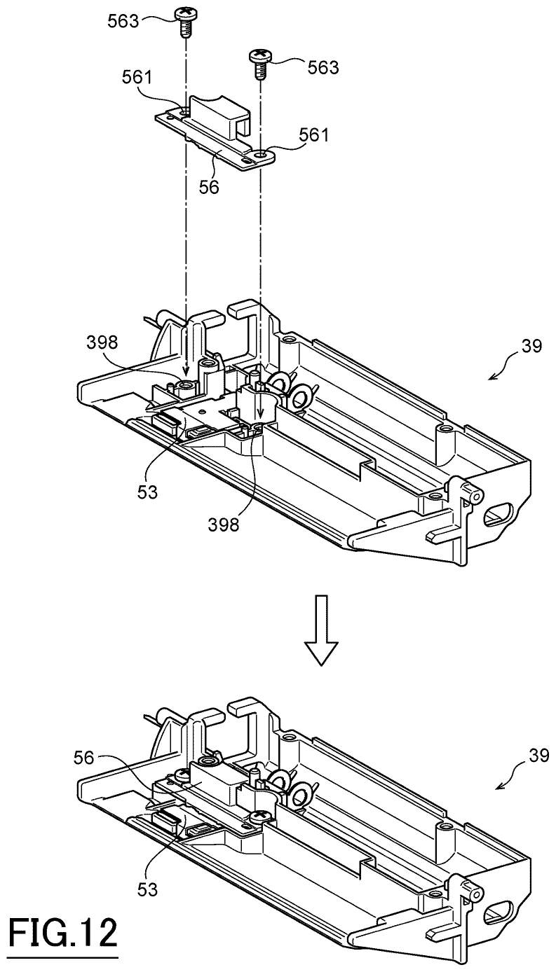

FIG. 11 and FIG. 12 illustrate a method for assembling the sensor assembly 53 to the head cover 39.

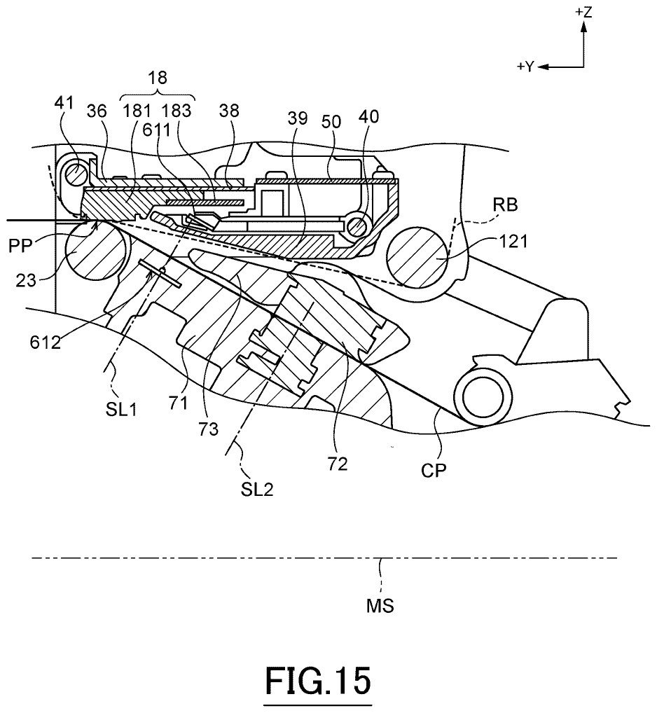

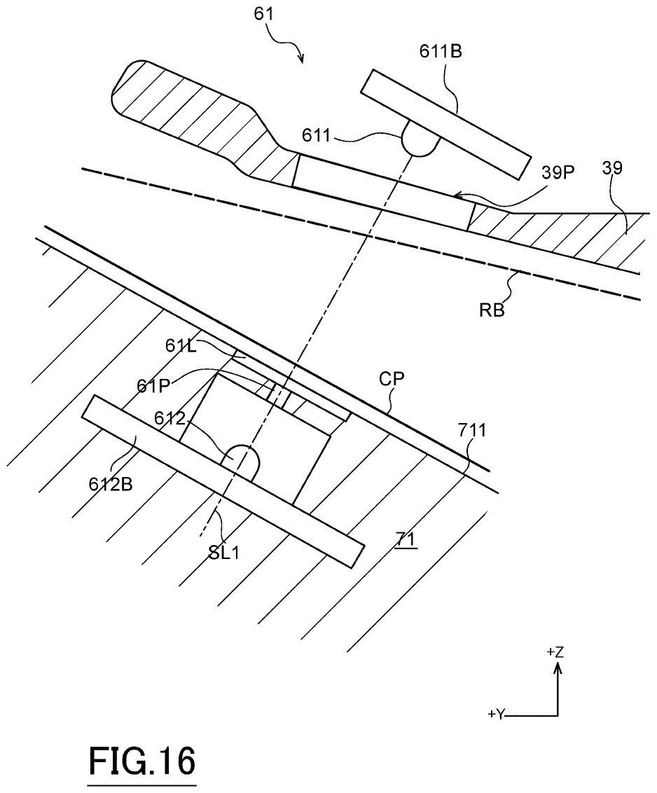

As illustrated in FIG. 11, the sensor assembly 53 includes the light-emitting element 611, a wire 613 connected to the light-emitting element 611, an accommodation member 55 (one example of the accommodation portion) accommodating the light-emitting element 611, and a cover 54 covering the accommodation member 55. The wire 613 extends out from the accommodation member 55, and is connected to the circuit board 50. The cover 54 of the sensor assembly 53 includes shaft insertion portions 541 through which the swing shaft 40 is inserted. The light-emitting element 611 constitutes the light transmission type sensor 61 together with a light-receiving element 612 (refer to FIG. 15 and FIG. 16) described below.

A sensor accommodation portion 397 is formed in the head cover 39. The sensor assembly 53 is accommodated in the sensor accommodation portion 397. The head cover 39 further includes a through-hole 39h that allows light emitted from the light-emitting element 611 to pass through the head cover 39.

As described below, the head cover 39 can move relative to the swing shaft 40 in the front-rear direction. Meanwhile, the sensor assembly 53 is supported by the swing shaft 40 via the shaft insertion portions 541. In other words, the light-emitting element 611 is supported by the swing shaft 40. For this reason, the sensor assembly 53 is arranged in the sensor accommodation portion 397 of the head cover 39 such that the head cover 39 is movable relative to the sensor assembly 53 in the front-rear direction. Thus, space efficiency is superior for arrangement of the light-emitting element 611 near the heat-generating element 18L of the thermal head 18.

Referring to FIG. 12, a holding member 56 is attached to the head cover 39 so as to prevent the sensor assembly 53 from being separated from the head cover 39. After the sensor assembly 53 is accommodated in the sensor accommodation portion 397, screws 563 are fastened to screw holes 398 in the head cover 39 via insertion holes 561 formed at two positions in the holding member 56.

In the manner described above, the light-emitting element 611 is accommodated in the head cover 39.

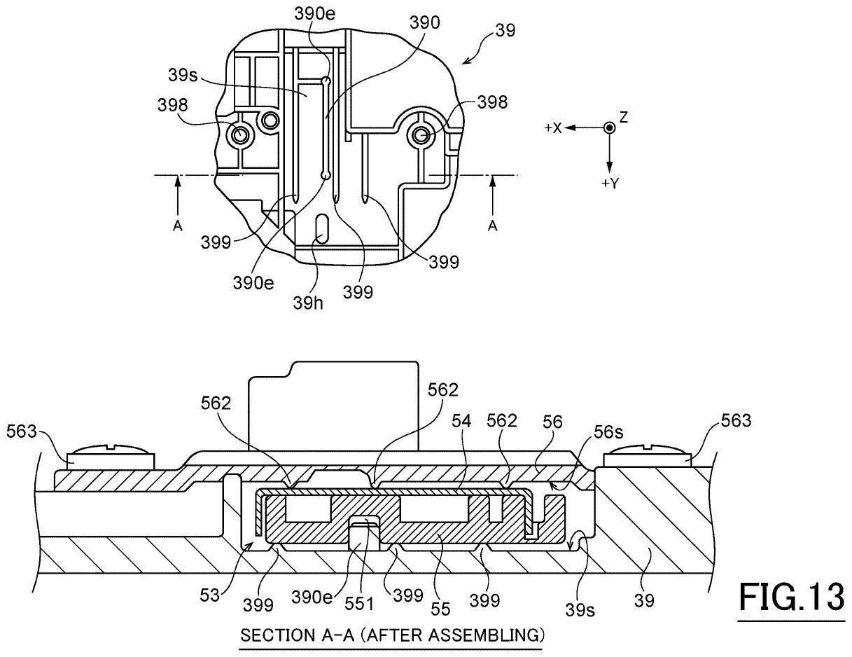

In a state where the holding member 56 is attached to the head cover 39, the accommodation member 55 guides the head cover 39 so as to be movable in the front-rear direction. A structure for implementing this guide function is described with reference to FIG. 13. FIG. 13 includes a partial plan view of a part in the head cover 39 where the sensor assembly 53 is arranged, and a sectional view of the A-A section. This sectional view illustrates the section A-A after the sensor assembly 53 and the holding member 56 are assembled to the head cover 39.

As illustrated by the plan view in FIG. 13, projections 399 are formed at three positions in the part of the head cover 39 where the sensor assembly 53 is arranged, and a protrusion 390 is formed in this part. The projections 399 and the protrusion 390 protrude upward from a bottom surface 39s of the head cover 39, and extend in the front-rear direction. The protrusion 390 includes bosses 390e formed at two positions that are one end and an opposite end of the protrusion 390 in the front-rear direction. Each of the bosses 390e is a cylindrical projection having a lateral-direction width larger than that of a portion connecting the two bosses 390e to each other. As illustrated by the sectional view in FIG. 13, a groove 551 for accommodating the protrusion 390 is formed on a bottom of the accommodation member 55. The groove 551 has a groove width equal to or slightly larger than the width of each of the bosses 390e of the projection 390.

Projections 562 are formed at three position on the holding member 56. The projections 562 protrude downward from a lower surface 56s of the holding member 56, and extend in the front-rear direction.

As illustrated by the sectional view in FIG. 13, when the sensor assembly 53 and the holding member 56 are assembled to the head cover 39, the projections 399 of the head cover 39 contact against a bottom surface of the accommodation member 55, and the projections 562 of the holding member 56 contact against an upper surface of the cover 54. Thereby, the sensor assembly 53 is restricted from moving relative to the head cover 39 in the up-down direction.

The bosses 390e at the two positions in the front-rear direction in the head cover 39 engage with the groove 551 on the bottom of the accommodation member 55. Thereby, the sensor assembly 53 is restricted from moving relative to the head cover 39 in the lateral direction.

Meanwhile, the head cover 39 can move relative to the sensor assembly 53 in the front-rear direction. At this time, the protrusion 390 of the head cover 39 and the groove 551 of the accommodation member 55 function as guides for the movement of the head cover 39 in the front-rear direction. A length of the groove 551 in the front-rear direction is set to be sufficiently larger than a length of the protrusion 390 in the front-rear direction such that an amount of the relative movement of the head cover 39 in the front-rear direction can be secured.

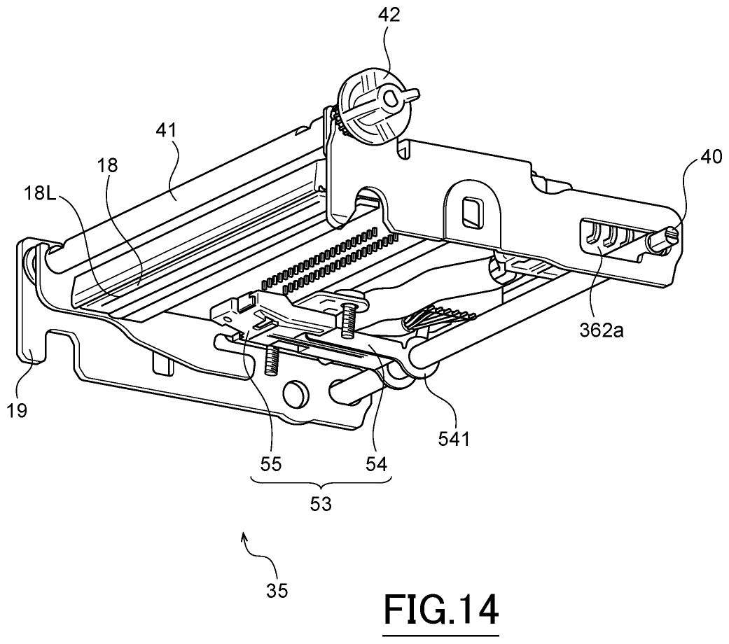

FIG. 14 illustrates the head mechanism unit 35 in FIG. 8 from which the head cover 39 has been detached.

As illustrated in FIG. 14, the sensor assembly 53 is supported by the swing shaft 40 via the shaft insertion portions 541. As illustrated in FIG. 8, in a state where the head cover 39 is attached, the through-hole 39h is formed in the head cover 39, and allows passing of light emitted from the light-emitting element 611 in the sensor assembly 53.

As illustrated in FIG. 5, the light-receiving element 612 that receives the light emitted from the light-emitting element 611 is incorporated in the label support part 71 as described below. The light-receiving element 612 is arranged downstream of the label guide 73 in the feed direction. For this reason, even when the sensor assembly 72 is made to slide in the width direction of the continuous paper CP, the light from the light emitting-element 611 reaches the light-receiving element 612 without being blocked.

As described above, the printer 1 includes the two light transmission type sensors that are the light transmission type sensor 62 (refer to FIG. 6) and the light transmission type sensor 61. The light transmission type sensor 62 is incorporated in the label support mechanism unit 70. The light transmission type sensor 61 includes the light-emitting element 611 accommodated in the head cover 39 and the light-receiving element 612 incorporated in the label support part 71. Since the two light transmission type sensors 61 and 62 are provided at the different positions in the feed direction, either sensor can be flexibly used depending on accuracy requirement for the print start position for each of the labels PL. The light transmission type sensor 61 is one example of the first detection unit, and the light transmission type sensor 62 is one example of the second detection unit.

Each of the light transmission type sensors is a sensor that detects the end (edge) of each label PL in the feed direction of the continuous paper CP. An output of the light transmission type sensor is used for feeding control for setting the print start position of each label PL to a position of the heat-generating part 18L of the thermal head 18.

Next, the positions of the two light transmission type sensors 61 and 62 are described with reference to FIG. 15. FIG. 15 is a sectional view of a part near the head cover 39 in the printer 1.

In FIG. 15, the sensor optical axis SL1 is a line connecting, to each other, the light-emitting element 611 and the light-receiving element 612 of the light transmission type sensor 61. The sensor optical axis SL2 is a line connecting, to each other, the light-emitting element 621 and the light-receiving element 622 (neither of which is illustrated in FIG. 15) of the light transmission type sensor 62. In other words, the light transmission type sensor 62 (sensor optical axis SL2) is provided upstream of the light transmission type sensor 61 (sensor optical axis SL1) in the feed direction of the continuous paper CP.

As illustrated in FIG. 15, the light-emitting element 611 of the light transmission type sensor 61 is arranged on an upper side of the feed path along which the ink ribbon RB is fed from the ribbon supply unit 12a toward the platen roller 23. Meanwhile, the light-receiving element 612 of the light transmission type sensor 61 is arranged in the label support part 71 on a lower side of the feed path along which the continuous paper CP is fed toward the platen roller 23. Accordingly, the light emitted from the light-emitting element 611 is transmitted through the ink ribbon RB and the continuous paper CP, and is then received by the light-receiving element 612. This configuration enables the light-emitting element 611 and the light-receiving element 612 to be positioned closer to a print position PP where the thermal head 18 and the platen roller 23 pinch the ink ribbon RB and the continuous paper CP. Thereby, accuracy of the print start position for each label PL can be improved.

As illustrated in FIG. 15, the light-emitting element 611 of the light transmission type sensor 61 is arranged between the heat sink 181 of the thermal head 18 and the ink ribbon RB.

As illustrated in FIG. 15, when the printer 1 is viewed from the side surface of the printer 1, a direction (i.e., the direction along the sensor optical axis SL1) from the position of the light-emitting element 611 toward the position of the light-receiving element 612 is inclined from an imaginary vertical line to a side on which the print position PP is set. The imaginary vertical line extends from the position of the light-emitting element 611 to the mounting surface MS on which the printer 1 is mounted. The imaginary vertical line is vertical to the mounting surface MS.

As illustrated in FIG. 15, when the printer 1 is viewed from the side surface of the printer 1, the thermal head 18 has a thickness that decreases along a direction opposite to the feed direction of the ink ribbon RB (also refer to FIG. 9). Thereby, a space is formed between the thermal head 18 and the ink ribbon RB. The light-emitting element 611 is arranged in this space.

With this configuration, the light-emitting element 611 is arranged in close proximity to the print position PP, and accordingly, the light-receiving element 612 is also arranged in close proximity to the print position PP. Thus, accuracy of the print start position for each label can be improved.

The light-receiving element 612 is arranged in the label support part 71. In other words, the light-emitting element 611 is arranged on an upper side of the feed path for the continuous paper CP fed toward the platen roller 23, and the light-receiving element 612 is arranged on a lower side of the feed path for the continuous paper CP. The reason for this is to enable stable reception of the light emitted from the light-emitting element 611. Since the label support part 71 is arranged on the support base 14 (refer to FIG. 4) and thus remains stationary, the light-receiving element 612 in the label support part 71 can stably receive the light. Meanwhile, the head cover 39 in which the light-emitting element 611 is arranged can be occasionally moved slightly due to transmission of vibrations of the head assembly 18A that accompany the printing operation.

However, arrangement of the light-emitting element and the light-receiving element in the light transmission type sensor 61 is not limited to this, and the light-emitting element 611 can be arranged on a lower side of the feed path for the continuous paper CP, and the light-receiving element 612 can be arranged on an upper side of the feed path for the continuous paper CP.

As illustrated in FIG. 15, the light transmission type sensor 62 (sensor optical axis SL2) is arranged on an upstream side along the feed path for the continuous paper CP, and the light transmission type sensor 61 (sensor optical axis SL1) is arranged on a downstream side along the feed path for the continuous paper CP. In this regard, luminance of the light-emitting elements of the two sensors may differ from each other. The light emitted from the light-emitting element 621 of the light transmission type sensor 62 is transmitted through only the continuous paper CP, whereas the light emitted from the light-emitting element 611 of the light transmission type sensor 61 is transmitted through the ink ribbon RB and the continuous paper CP. In addition, a distance between the light-emitting element and the light-receiving element differs between the sensors. Thus, luminance of the light-emitting element 611 may be higher than luminance of the light-emitting element 621. The luminance of the light-emitting elements can be individually adjusted to an optimum value.

FIG. 16 is an enlarged view of a part in FIG. 15, which is related to the light transmission type sensor 61 (the light-emitting element 611 and the light-receiving element 612).

As illustrated in FIG. 16, the light-emitting element 611 is arranged on a substrate 611B, and the light-receiving element 612 is arranged on a substrate 612B. The substrate 611B is fixed in the accommodation member 55 (refer to FIG. 11). The substrate 612B is arranged in the label support part 71.

A dustproof sheet 61L is attached to the support surface 711 of the label support part 71. Further, a narrow passage 61P through which the light passes is formed along the sensor optical axis SL1 from the sheet 61L. The transmission light that has been transmitted through the continuous paper CP along the sensor optical axis SL1 reaches the light-receiving element 612 via the sheet 61L and the passage 61P. A lens may be used instead of the sheet 61L.

From the standpoint of improving detection accuracy of the light transmission type sensor 61, the light-receiving element 612 is preferably positioned on the same plane as the support surface 711 or near the support surface 711. In other words, a length of the passage 61P is as short as possible. Positioning the light-emitting element 611 near the support surface 711 can cause a large difference (high contrast) in received light intensity between the light transmitted through the label PL and the liner PM and the light transmitted through only the liner PM in the continuous paper CP fed on the support surface 711. Once the light enters the passage 61P, the light does not diffuse any further even when the passage 61P having a relatively short length is provided between the support surface 711 and the light-receiving element 612 as illustrated in FIG. 16. For this reason, the above-described high contrast can be achieved without being hindered. Since a light transmissivity of one or each of the ink ribbon RB and the continuous paper CP varies depending on a thickness and a material of the ink ribbon RB or the continuous paper CP, luminance of the light emitted from the light-emitting element 611 may be adjusted as appropriate to achieve the optimal contrast.

In other words, the light-receiving element 612 of the light transmission type sensor 61 receives, at the support surface 711 of the label support part 71, the light that has been emitted from the light-emitting element 611 and transmitted through the ink ribbon RB and the continuous paper CP. Here, the term “receives the light at the support surface 711” means receiving the light on the same plane as the support surface 711, or receiving the light via the optical path in which the light incident from the support surface 711 does not significantly spread.

In one embodiment, as illustrated in FIG. 16, the feed path for the ink ribbon RB is positioned directly below the light-emitting element 611. Positioning the light-emitting element 611 as close to the ink ribbon RB as possible can decrease a distance between the light-receiving element 612 and the light emitting-element 611, and thereby facilitate luminance adjustment for achieving the above-described satisfactory contrast.

As illustrated in FIG. 15, a front portion of the head cover 39 is arranged between the substrate 183 of the thermal head 18 and the feed path for the ink ribbon RB. The light-emitting element 611 is accommodated in the sensor accommodation portion 397 (FIG. 11) provided in the front portion of the head cover 39, and is arranged directly below the substrate 183 of the thermal head 18. In other words, a shape of the thermal head 18 is set so as to allow the light-emitting element 611 to be arranged directly below the substrate 183 of the thermal head 18, and the light-emitting element 611 accommodated in the front portion of the head cover 39 is arranged in the space directly below the substrate 183. For this reason, the light-emitting element 611 is arranged near the print position PP, and thus, accuracy of the print start position for each label PL based on the light transmission type sensor 61 can be improved.

As illustrated in FIG. 15, the feed path for the ink ribbon RB and the feed path for the continuous paper CP are configured so as to extend downward along an upstream direction from the print position PP. Since the feed path for the ink ribbon RB and the feed path for the continuous paper CP extend downward (i.e., toward the mounting surface on which the printer 1 is mounted) along an upstream direction from the print position PP, a space is formed between the head cover 39 on a rear side of the print position PP and each of the feed paths, and thus, the light-emitting element 611 can be arranged near the heat-generating part 18L of the thermal head 18.

As illustrated in FIG. 15, the label guide 73 is arranged so as to partition the feed path for the continuous paper CP from the feed path for the ink ribbon RB. As a result, the ink ribbon RB fed from the ribbon roller 121 toward the print position PP and the continuous paper CP fed from the damper 15 (refer to FIG. 3; not illustrated in FIG. 15) toward the print position PP gradually approach each other. Accordingly, a predetermined distance between the continuous paper CP and the ink ribbon RB can be secured at the position of the sensor optical axis SL1. Thereby, the above-described satisfactory contrast can be achieved.

In one embodiment, the label guide 73 is arranged upstream of and close to the sensor optical axis SL1 in the feed direction. Since the label guide 73 guides the continuous paper CP from above (i.e., from a side of the label), a movement amount of the continuous paper CP in a direction perpendicular to the liner PM is restricted (i.e., fluttering of the continuous paper CP is suppressed). Thus, the light-receiving element 612 of the light transmission type sensor 61 positioned slightly downstream of the label guide 73 can receive the light with reduced fluctuation emitted from the light-emitting element 611. Thereby, detection accuracy of the light transmission type sensor 61 is improved.

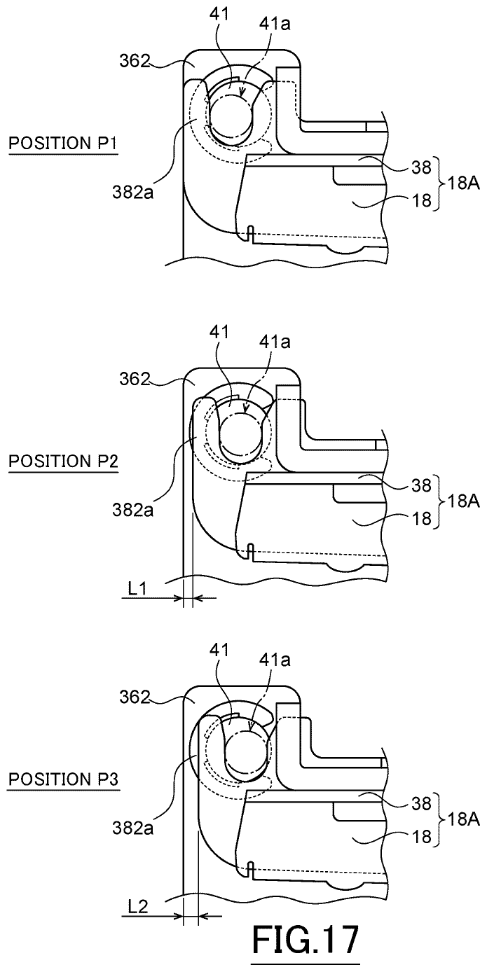

Next, an effect of the head position adjustment mechanism is described with reference to FIG. 17. As described above, the head position adjustment refers to adjusting a position of the thermal head 18 in the front-rear direction in response to rotational operation of the operational portion 42 (FIG. 7).

FIG. 17 includes side views of the head holder 36 and the head assembly 18A in the vicinity of the rotational shaft 41, and illustrates different positions P1 to P3 of the thermal head 18 in the front-rear direction.

The rotational shaft 41 includes a fitting portion 41a onto which the cutout 382a is fitted. The fitting portion 41a is eccentric to a central rotational shaft portion of the rotational shaft 41. Accordingly, when the rotational shaft 41 is rotated by the operational portion 42, the fitting portion 41a traces a trajectory that involves movement in the front-rear direction. Consequently, the cutouts 382a are moved in the front-rear direction (i.e., the head assembly 18A is moved in the front-rear direction). In FIG. 17, the position P2 is a position where the fitting portion 41a has been moved rearward by a distance L1 from the position P1. The position P3 is a position where the fitting portion 41a has been moved rearward by L2 (>L1) from the position P1.

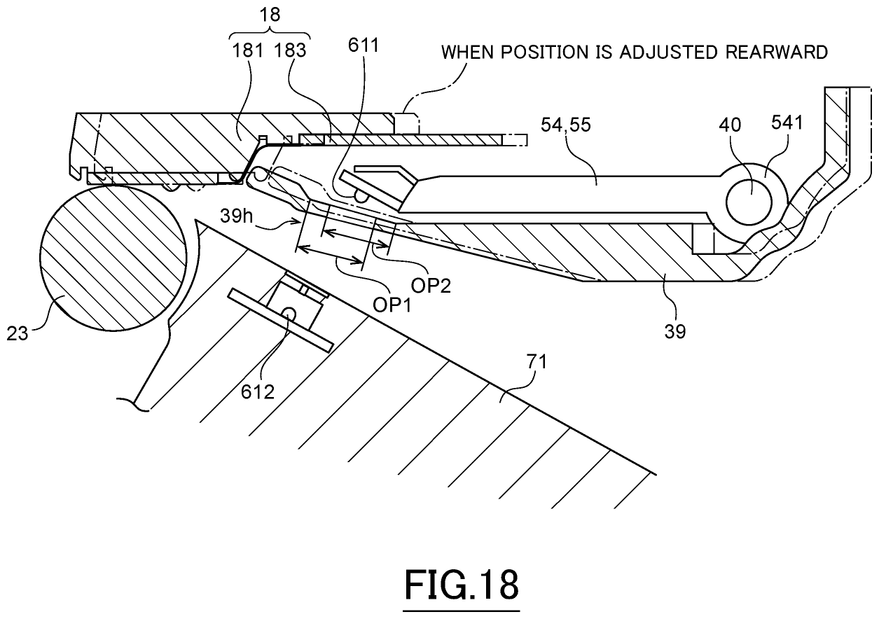

When the head assembly 18A is moved in the front-rear direction by the head position adjustment mechanism, the head cover 39 linked to the head assembly 18A is also moved in the font-rear direction in conjunction with the head assembly 18A, whereas the position of the light-emitting element 611 is not changed. This point is described with reference to FIG. 18.

FIG. 18 is a partial sectional view illustrating a positional relation in the vicinity of the light transmission type sensor 61 before and after the head position adjustment. FIG. 18 depicts, with the solid lines, a state before the head position is adjusted, and depicts, with the one-dot chain lines, a state after the head position is adjusted rearward. As illustrated in FIG. 18, when the head position is adjusted rearward, the head assembly 18A and the head cover 39 are moved rearward in conjunction with the head position adjustment. Here, the insertion hole 395 of the head cover 39 is a hole elongated in the front-rear direction as illustrated in FIG. 10, and thus allows the head cover 39 to be moved in the front-rear direction together with the head assembly 18A.

Even when the head assembly 18A and the head cover 39 are moved rearward, the swing shaft 40 is stationary because of being fixed to the internal frame (not illustrated). The accommodation member 55 that accommodates the light-emitting element 611 guides the head cover 39 and the holding member 56 (FIG. 12) attached to the head cover 39 such that the head cover 39 and the holding member 56 are movable in the front-rear direction. However, the accommodation member 55 is supported by the swing shaft 40 via the shaft insertion portions 541, and thus is stationary.

Accordingly, even when the head assembly 18A is moved in the front-rear direction by the head position adjustment mechanism, the light-emitting element 611 is not moved in the front-rear direction. Thus, an optical path of the light emitted from the light-emitting element 611 is not shifted, and the light-receiving element 612 can stably receive the light.

The movement of the head assembly 18A and the head cover 39 does not cause the position of the light-emitting element 611 to be changed. However, the through-hole 39h through which the light emitted from the light-emitting element 611 passes is moved together with the head cover 39 in the front-rear direction. In view of it, the through-hole 39h is preferably elongated in the front-rear direction such that the light emitted from the light-emitting element 611 reliably passes toward the light-receiving element 612 even when the head cover 39 is moved in the front-rear direction. In FIG. 18, OP1 denotes an opening range of the through-hole 39h in the elongated direction before the head position is adjusted, and OP2 denotes an opening range of the through-hole 39h in the elongated direction after the head position is adjusted rearward. Since the through-hole 39h is elongated in the front-rear direction, the light emitted from the light-emitting element 611 is not blocked in either of the opening ranges OP1 and OP2 before and after the head position adjustment.

As described above, in one embodiment, the light-receiving element of the light transmission type sensor receives, at the support surface of the label support part, the light that has been emitted from the light-emitting element and transmitted through the ink ribbon and the continuous paper. Since the ink ribbon and the continuous paper are fed to a position between the light-emitting element and the light-receiving element, the light-emitting element and the light-receiving element can be at a position upstream of and in the close vicinity of the print position. Thus, accuracy of the print start position for each label can be improved.

In one embodiment, the light-receiving element is provided in the label support part that supports the continuous paper from below the feed path. Since the label support part is stationary at the time of printing on the continuous paper, the light-receiving element can stably receive the light from the light-emitting element.

In one embodiment, the light-receiving element receives, at the support surface supporting the continuous paper, the light from the light-emitting element. This can achieve a large difference (high contrast) in received light intensity between the light transmitted through the label and the liner and the light transmitted through only the liner, concerning the light that has been transmitted through the ink ribbon and the continuous paper.

In one embodiment, the light-emitting element of the light transmission type sensor is supported by the swing shaft inserted through the head cover. For this reason, even when the head assembly and head cover are moved in the front-rear direction by the head position adjustment, the light-emitting element supported by the swing shaft is stationary, and can stably operate to emit the light. Thus, a decline in label detection accuracy can be avoided.

Although the embodiments of the printer according to the present invention are described above, the present invention is not limited to the above-described embodiments. The above-described embodiments can be variously improved or modified without departing from the essence of the present invention.

The present invention is related to Japanese Patent Application No. 2023-54575 filed with the Japan Patent Office on Mar. 30, 2023 and Japanese Patent Application No. 2024-46060 filed with the Japan Patent Office on Mar. 22, 2024. The entire contents of these Applications are incorporated by reference into “Description” of the present application.

1. A printer comprising:
a feed roller that feeds a continuous body and an ink ribbon, the continuous body including a band-shaped liner and a plurality of print media peelably attached at intervals on the liner;
a print head that prints information on each of the print media of the continuous body, the print head and the feed roller pinching the ink ribbon and the continuous body at a print position; and
a first detection unit that is provided upstream of the print position in a feed direction of the continuous body, the first detection unit comprising a light-emitting element and a light-receiving element receiving, via the ink ribbon and the continuous body, light emitted from the light-emitting element, to detect an end of each of the print media in the feed direction of the continuous body.

2. The printer according to claim 1, further comprising
a medium support part that includes a support surface supporting, from a side of the liner, the continuous body fed toward the feed roller, wherein
the light-emitting element is arranged on a side on which the print head is provided, relative to a feed path along which the ink ribbon is fed toward the feed roller, and
the light-receiving element receives the light at the support surface.

3. The printer according to claim 1, wherein
the print head includes a substrate on which a heat-generating part is provided, and
the light-emitting element is arranged directly below the substrate.

4. The printer according to claim 1, wherein
the print head includes a heat-dissipating part, and
the light-emitting element is arranged between the heat-dissipating part and the ink ribbon.

5. The printer according to claim 1, wherein
when the printer is viewed from a side of the printer, a direction from a position of the light-emitting element toward a position of the light-receiving element is inclined from an imaginary vertical line to a side on which the print position is set, the imaginary vertical line extending from the position of the light-emitting element, vertical to a mounting surface on which the printer is mounted.

6. The printer according to claim 1, wherein
when the printer is viewed from a side of the printer, the print head has a thickness that decreases along a direction opposite to a feed direction of the ink ribbon, and thereby, a space is formed between the print head and the ink ribbon, and
the light-emitting element is arranged in the space.

7. The printer according to claim 1, wherein
a feed path for the ink ribbon and a feed path for the continuous body are set so as to approach a mounting surface for the printer along an upstream direction from the print position, the mounting surface being a surface on which the printer is mounted.

8. The printer according to claim 3, further comprising
a head cover arranged between the substrate and a feed path for the ink ribbon, wherein
the light-emitting element is accommodated in the head cover.

9. The printer according to claim 8, wherein
a through-hole is formed in the head cover to allow light emitted by the light-emitting element to pass through the through-hole.

10. The printer according to claim 1, further comprising
a guide that is provided upstream of the light-receiving element in the feed direction, and guides, from a side of the print medium, the continuous body fed toward the feed roller.

11. The printer according to claim 1, further comprising
a second detection unit that is provided upstream of the first detection unit in the feed direction of the continuous body, and detects an end of each of the print media in the feed direction of the continuous body, wherein
the second detection unit includes a light-emitting element and a light-receiving element arranged such that one of the light-emitting and light-receiving elements in the second detection unit is more distanced from a mounting surface for the printer than another of the light-emitting and light-receiving elements in the second detection unit and is arranged between a feed path for the ink ribbon and a feed path for the continuous body, the mounting surface being a surface on which the printer is mounted.

12. The printer according to claim 2, wherein
the print head includes a substrate on which a heat-generating part is provided, and
the light-emitting element is arranged directly below the substrate.

13. The printer according to claim 2, wherein
the print head includes a heat-dissipating part, and
the light-emitting element is arranged between the heat-dissipating part and the ink ribbon.

14. The printer according to claim 3, wherein
the print head includes a heat-dissipating part, and
the light-emitting element is arranged between the heat-dissipating part and the ink ribbon.

15. The printer according to claim 12, wherein
the print head includes a heat-dissipating part, and
the light-emitting element is arranged between the heat-dissipating part and the ink ribbon.
